(19) United States
(12) Patent Application Publication
(10) Pub. No.: US 2009/0177482 A1
(43) Pub. Date: Jul. 9, 2009

(54) Method of improving concrete production by monitoring weather conditions

(76) Inventors: Michael D. Granruth, Centreville, VA (US); Trent C. Hone, Arlington, VA (US)

Correspondence Address: Vollrath & Associates, 588 Sutter Street #531, San Francisco, CA, 94102, US

(21) Appl. No.: 12/008,115

(22) Filed: Jan. 7, 2008

(51) Int. Cl. G06Q 99/00

(52) U.S. Cl. 705/1

(57) ABSTRACT

In a concrete preparation and pouring process, concrete quality and batch consistency is improved by monitoring weather conditions at one or more locations relating to the process and taking the weather conditions into account in adjusting variables in the preparation and pouring process.

### FIELD OF THE INVENTION

The invention relates to the production of concrete. In particular it deals with improving the quality and consistency with which concrete is produced.

### BACKGROUND OF THE INVENTION

In order to improve concrete and provide greater consistency with which concrete is produced sensors are used on concrete mixers to provide feedback regarding the status of a project, such as the loading of the concrete mixer with the raw materials, i.e., cement, sand, gravel, water, the leaving of the concrete mixer from a plant, the arrival of the concrete mixer at a job site, and the pouring of the concrete.

However, environmental factors, such as precipitation and temperature can effect the outcome of a concrete related project, also referred to as concrete jobs. The present invention seeks to take weather conditions into account in order to improve concrete jobs.

### SUMMARY OF THE INVENTION

According to the invention there is provided a method of providing concrete, comprising obtaining location information for a concrete mixer or for a concrete job site during one or more events of a concrete preparation and pouring process, obtaining weather information for the location, and doing one or both of capturing the weather information in a data store, such as a database, and providing the weather information to the location.

The location information may be obtained using a GNSS receiver such as a GPS, Galileo, GLONASS, Beidou, or other Satellite Based Augmentation System (SBAS) receiver, which may be mounted on the concrete mixer or at the job site. The location information is typically transmitted to a central location, e.g., by means of a radio or cellular phone link.

The weather information may includes one or more of humidity, precipitation, wind speed, wind direction, and temperature, and may be obtained from at least one weather data gathering site. Preferably the weather information is obtained from a plurality of weather data gathering sites. In particular it may be obtained from a weather gathering service, such as Weatherbug, that uses multiple weather data gathering sites and interpolation to provide weather data for specified locations. The capture of the weather information for specified locations may be at one or more central locations

In addition to the weather information, the method may include obtaining sensor information about the concrete during one or more events during the loading, preparation, and pouring process. The sensor information may be transmitted to the same central location where the weather information is gathered or to another central location. The sensor information about the concrete may be captured in a data store, such as a database, which may be the same database or a different one to the database in which the weather information is captured and again may be captured at more than one central location. The sensor information about the concrete may be obtained during events that may include at least one of the concrete mixer being loaded, the concrete mixer leaving a plant, the concrete mixer arriving at job site, and the concrete mixer pouring concrete.

For purposes of on-site use of the weather information, the weather information itself or amended concrete preparation process instructions based on the weather information may be transmitted to the job site or the concrete mixer.

### BRIEF DESCRIPTION OF THE DRAWINGS

FIG. 1 is a simplified representation of events involved in a concrete job, in accordance with the invention.

### DETAILED DESCRIPTION

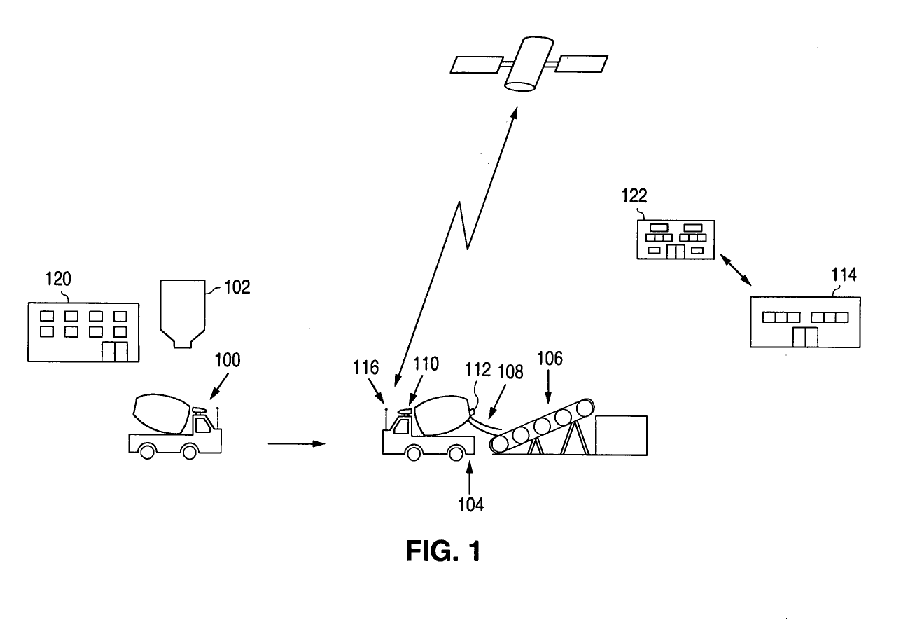

In a concrete preparation and pouring job, which for purposes of convenience is also referred to herein simply as a concrete job, the raw materials, cement, gravel, sand, water are typically loaded into the concrete mixer 100 from hoppers or other storage containers 102 at a central location, as shown in FIG. 1. Once the mixer 100 is loaded, which may mark the first event in a concrete job, the mixer may depart from the loading site, thereby marking the second event in the job. The third event 104 may then involve the arrival of the mixer 100 at the job site, as depicted here by the conveyor belt 106. The concrete is then poured as depicted by event 108. It will be appreciated that the events given above are by way of example only and that other or additional events may be of interest and worth monitoring.

In order to monitor the location of the mixer during one or more events of the concrete preparation process, the concrete mixer 100 is provided by a GPS receiver 110 or other GNSS receiver such as a Galileo, GLONASS, Beidou, or other Satellite Based Augmentation System (SBAS) receiver. In another embodiment the location of a job site may be monitored by providing a GNSS receiver at the job site. In the present embodiment the mixer 100 is also provided with one or more sensors 112 for monitoring activity of the hardware on the concrete mixer 100 such as the speed of rotation of the concrete drum, the direction it is turning, the quantity of water that has been added to the concrete mix, whether or not the washout hose is in operation, etc. In another embodiment sensors 112 are provided for measuring (in addition to hardware or instead of measuring aspects of the hardware) aspects of the concrete such as the temperature, moisture, and slump (a measure of the viscosity of the mixture). The location information and other sensor information is then transmitted in this embodiment to a central location 114, e.g., a Trimble data capture site, where the information is captured in a database. In this embodiment the information is transmitted to the central location 114 by means of a radio link depicted here by radio transceiver antenna 116.

It will be appreciated that in another embodiment, the sensor and location information, which together provide what will be referred to herein as event information, could be sent directly to a central location 120 of the concrete producing company where it could be captured in a data store such as a database. In yet another embodiment, the sensor and location information is captured at both central location 114 as well as the central location 120. Also, instead of a radio link the transceiver may be a cellular phone or other communications link.

In accordance with the invention, the event information is supplemented with weather related information such as the temperature, wind conditions, humidity, precipitation and any other weather related information that may impact the quality of the concrete or the consistency with which the concrete is provided at the job site. For instance, if whether conditions indicate high precipitation at the loading site 102, this would be relevant to the quantity of water added to the mix in producing the concrete. The weather information in this embodiment is obtained by determining the location of the mixer truck or the job site related to the event in question and then obtaining a weather estimated for that location based on weather information gathered from multiple weather stations and weather monitoring sites. Such information is, for instance, provide by Weatherbug, which gathers information at a central location 122 from a plurality of weather stations and weather monitoring sites and makes the weather information available on-line, where location-specific weather can be downloaded by specifying the location of interest and having the location-specific information calculated by interpolation. Thus, by making use of the GNSS receiver 110 on the mixer 100 and transmitting the location information to the central location 114, for instance, the location information can be entered into the system provided by Weatherbug to obtain location-specific weather. In the present embodiment, the specific weather information associated with the events is then transmitted from the central location 114 to the central location 120 of the concrete manufacturer, where it is entered into a database for monitoring weather impacts on the quality and batch consistency of concrete. In another embodiment the weather information is also or instead captured in a database at the central location 114. The weather information, in one embodiment, is also used to recalculate variables that can be changed in order to improve concrete quality. For example variables such as the temperature and chemical composition of the concrete mixture can be adjusted by introducing additives (also referred to as Admixtures). Also water can be added to the mixture while the concrete mixer is en route and after arrival at the job site. In one embodiment the recalculated variables are relayed to the mixer 100 by means of the radio transceiver 116, to allow on-site adjustment of certain variables during one or more of the events. It will be appreciated that in another embodiment, the location-specific weather information can be captured at the central location 114 in addition to or instead of at the central location 120. Also, instead of recalculating variables at the central location 120, the weather information can, in another embodiment, be sent directly to the mixer truck for recalculation of the variables on-site.

Thus the present invention provides a method of improving concrete quality and ensure greater batch consistency by determining weather conditions at one or more locations during the course of preparation and pouring of the concrete. These locations are referred to herein as event sites and may correspond to the event sites at which sensor 112 information is monitored. On the other hand the event sites for the sensors 112 may be different from the event sites at which whether information is required to be monitored. It will also be appreciated that the location where the various sources of information, whether it be sensor or weather information or location information, is gathered or processed may vary from embodiment to embodiment.

What is claimed is:

1. A method of providing concrete, comprising
obtaining location information for at least one of a concrete mixer and a concrete job site during one or more events during a concrete preparation and pouring process,
obtaining weather information for said at least one location, and
performing at least one of capturing the weather information in a data store and providing the weather information to said at least one location.

2. A method of claim 1, wherein the location information is obtained using a GNSS receiver.

3. A method of claim 2, wherein the GNSS receiver includes at least one of a GPS, Galileo, GLONASS, Beidou, or other Satellite Based Augmentation System (SBAS) receiver.

4. A method of claim 2, wherein the GNSS receiver is mounted on the concrete mixer.

5. A method of claim 1, further comprising transmitting the location information to a central location.

6. A method of claim 5, wherein the location information is transmitted by means of a radio or cellular phone link.

7. A method of claim 1, wherein the weather information includes at least one of humidity, precipitation, wind conditions, and temperature.

8. A method of claim 7, wherein the weather information is obtained from at least one weather data gathering site.

9. A method of claim 8, wherein the weather information is obtained from a plurality of weather data gathering sites.

10. A method of claim 9, wherein the weather information is obtained from a weather gathering service that uses multiple weather data gathering sites and interpolation to provide weather data for specified locations.

11. A method of claim 1, further comprising obtaining sensor information relating to at least one of the concrete mixer and aspects of the concrete.

12. A method of claim 5, further comprising obtaining sensor information relating to at least one of the concrete mixer and aspects of the concrete and transmitting the sensor information to said central location or another central location.

13. A method of claim 12, further comprising capturing the sensor information about the concrete in at least one data store.

14. A method of claim 13, further comprising capturing the weather information in one or more of said data stores or one or more other data stores.

15. A method of claim 8, further comprising transmitting the weather information relating to said at least one location to said at least one location.

16. A method of claim 11, wherein the sensor information about the concrete is obtained during one or more events, which include at least one of concrete mixer being loaded, concrete mixer leaving a plant, concrete mixer arriving at job site, concrete mixer pouring concrete.

17. A method of claim 11, further comprising using the sensor information and weather information to recalculate one or more variables relating to the concrete mixture and adjusting said one or more variables.

18. A method of claim 14, further comprising using the sensor information and weather information to recalculate one or more variables relating to the concrete mixture and transmitting to the concrete mixer information for adjusting said one or more variables.

19. A method of claim 17, wherein the variables include temperature of the concrete mixture and amount of water to be added to the concrete mixture.

20. A method of claim 18, wherein the variables include temperature of the concrete mixture and amount of water to be added to the concrete mixture, and the information for adjusting said one or more variables includes any admixtures to be added to the concrete mixture and the amount of water to be added to the concrete mixture.
